(19) United States
(12) Patent Application Publication
(10) Pub. No.: US 2012/0203917 A1
(43) Pub. Date: Aug. 9, 2012

(54) METHOD TO LINK DEVICES WITH EACH OTHER VIA A NETWORK

(76) Inventor: Rakan Khaled Y. Alkhalaf, Riyadh (SA)

(21) Appl. No.: 13/501,537

(22) PCT Filed: Oct. 16, 2009
(86) PCT No.: PCT/EP09/63599

§ 371 Date: Apr. 12, 2012

(51) Int. Cl. G06F 15/16; G06F 17/30

(52) U.S. Cl. 709/228

(57) ABSTRACT

There is provided a method to link a first device (1) that is linked with a network (3) with at least one further device (2) that is linked with the network (3). A remote server (4) having a database (40) comprising information regarding rules to connect said devices (1, 2) with each other is linked to the network (3). Said connection is established via the network (3) and the remote server (4). The devices (1, 2) comprise a network interface (10, 20) allowing communication with the network (3) and an identification interface (11, 21) to identify a user, wherein in a first step the user identifies himself vis-à-vis the first device (1) over the identification interface (11, 21) wherein a set of identification data is generated by said identification interface (11, 21), whereby afterwards the set of identification data and the address of the first device (1, 2) will be submitted as a set of information (5) to the remote server (3) and wherein in subsequent step the user identifies himself vis-à-vis the further device (2) over the identification interface (11, 21) wherein a set of identification data is generated by said identification interface (11, 21), whereby afterwards the set of identification data and the address of the further device (1, 2) will be submitted as a set of information (5) to the remote server (3). The database (40) in the remote server (4) will be queried based on said set of information; and the database establishes a link (8) between the first device (1) and the further device (2).

### TECHNICAL FIELD

The present invention refers to a method to link at least two devices, such as peripheral devices, via a network with each other according to claim 1.

### PRIOR ART

From prior art there are several methods known to link two devices such as a first computer with a second computer via a network together.

However, with increasing performance of networks concerning data throughput the need for alternative methods to link devices with each other via a network arises.

This need further increases due to the popularity of home office programmes where people work at home for a company, but need to be linked with parts of the company's computer system in order to have access to and to retrieve stored data or information. Thereby the computer system itself may also be organised in de-centralized manner which means that for example storage device are located in a location remote from the processing devices.

From prior art game gears such as Sony's Playstation, Nintendo's Wii or Microsoft's X-Box are also known. A user of such game gears may join the game of other users, whereby the at least two game gears will be linked together via a network such as the internet. Thereby the linking procedure is very limited and the main computing operation is conducted at the location of each user.

A further problem of prior art is that applications are installed on the users computer which makes it difficult for the system administrator to manage said applications. Furthermore fraudulent use of software is performed by copying software on CD-ROM and distributing the illegally. Neither the system administrator nor the manufacturer of the software has means to control and prevent such a misuse.

Furthermore it is an increasing need that users have access to their data, irrespective of the location of the user. Although users wish to have easy access to the their data, security and availability are very important for the user.

### SUMMARY OF THE INVENTION

It is an object of the invention to provide a method to link a first device which can be an input device such as a keyboard with at least one further device which can be an output device such as a display over a network, whereby the procedure of linking the devices shall be automatically performed.

Such an object is solved by the method to link a first device with a further device according to claim 1. Thereby a method is provided to link a first device that is linked with a network with at least one further device that is linked with the network, wherein a remote server having a database comprising information to connect said devices with each other is linked to the network, wherein said connection is established via the network and the remote server. Said devices comprise a network interface allowing communication with the network and an identification interface to identify a user. In a first step the user identifies himself vis-à-vis the first device and subsequently vis-à-vis the further device over the identification interface wherein a set of identification data is generated by said identification interface. After the identification the respective set of identification data and the address of the respective device will be submitted as a set of information to the remote server. Then the database in the remote server will be queried based on said set of information. The database establishes a link between the first device and the further device.

With the method as mentioned the user intending to link two devices together is provided with a very easy procedure as the only step that has to be initiated by the user is providing information concerning the user's identity. The further linking procedure will be done in an automatic manner.

Preferably a remote processing unit which processes processing requests from the user will be linked automatically to the first and/or the further device by means of linking information stored in the database. Alternatively the remote server provides a graphical user interface with which the user can choose a remote processing unit. The remote processing unit can either be located at the location of the remote server or elsewhere including also the location of the user itself. This is also advantageous for the system administrator as maintenance of software applications become rather easy, since maintenance is restricted to one server only and not to several work stations. Furthermore this provides also the advantage for software companies as the remote server may be operated by them which limits fraudulent distribution.

Preferably the step of querying the database includes the sub-steps of:
storing the set of information received from the first device.
querying the database upon receipt of a further set of information, if there is a matching set of information and
establishing a link between the first device and the further device, if a matching set of information is found.

A registering step is preferably performed before the first step, whereby the user provides at least identity data concerning his identity and wherein said data is stored in the database. The registering step is to be considered as the step that has to be performed in order to enable a user to use the system. Thereby the registering step can also be used by a provider of a system to enhance security by running a security upon receipt of the identity data.

Preferably the database comprises linking information in relation to identification data, whereby the input devices and/or the output devices are allocated to remote devices automatically once the identification data has been entered.

Preferably the step of identification vis-à-vis a further device is performed by manually choosing said further device from a list which is provided for the first device by means of said database and by an identification step vis-à-vis said further device, wherein said identification step preferably includes an input of identification information.

In a more preferred embodiment the identification data which has been entered via the first device will be stored in a table of the database and wherein said table is questioned every time upon receipt of further identification data from a further device, and wherein in case of matching identification data the first device will be linked with a further device.

### SHORT DESCRIPTION OF THE FIGURES

Preferred embodiments of the invention will be described in the following description with reference to the drawings, which are to be understood as explanation and not as limiting the scope of protection.

FIG. 1 shows a schematic view of a system which can be operated according to a method of the present invention; and

FIG. 2 shows a further schematic view of the structure according to the present invention.

### DESCRIPTION OF PREFERRED EMBODIMENTS

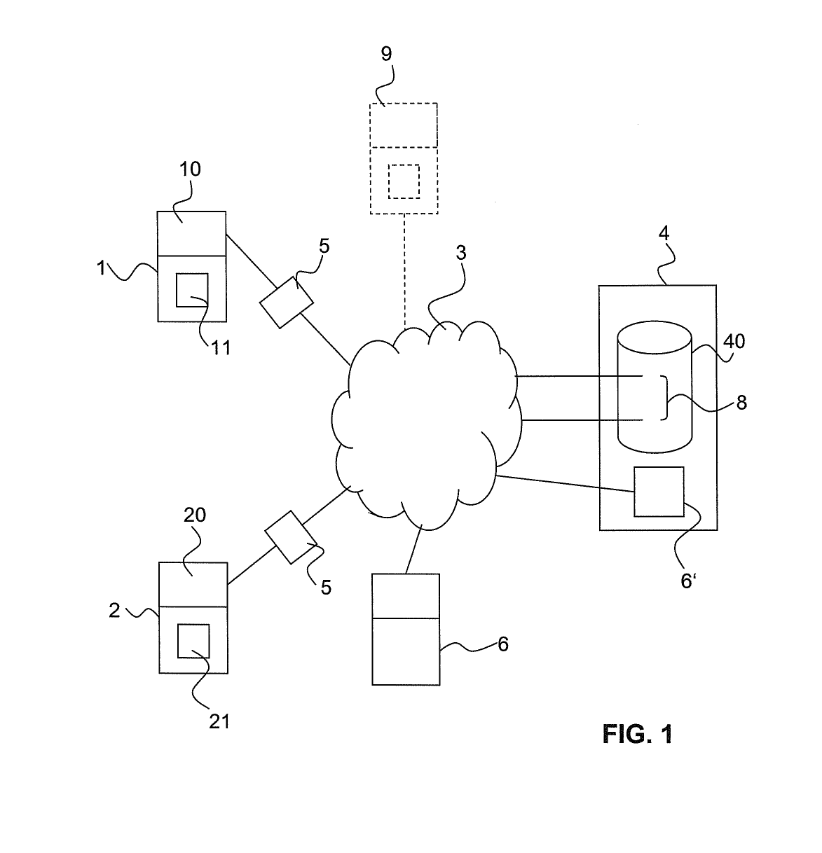

FIG. 1 shows a system which can be operated according to a method as described below.

The system comprises a plurality of devices, here a first device 1 and a further or second device 2, a network 3 and a remote server 4. The first device 1 and the further device 2 are linked to the network 3. The remote server 4 is also linked to the network 3. With the method as described below it is possible to link the first device 1 with at least one further device 2 via the network 3 and via the remote server 4.

Furthermore the system may also comprise a processing unit 6 or 6′ which can be arranged at a remote location as it is shown with processing unit 6 or at the same location where the remote server 4 is arranged as it is shown with processing unit 6′. The processing unit processes information request that will be entered via the devices 1, 2 and the processed information will be provided to the user via said devices 1, 2. For the method as described herein it is not mandatory to have the processing unit 6, 6′ as the method to link the first device 1 with the further device 2 can be performed without the processing unit.

However, the processing unit 6 may also be located in the vincinity of said devices 1, 2, whereby the method here serves apart from linking the devices via the remote server together also as an authentication method in order to provide the user with the permission to use the devices 1, 2 and the processing unit 6.

The devices 1, 2 are peripheral devices of a computer system comprising at least a network interface 10, 20 allowing communication with the network 3, an identification interface 11, 21 to identify a user intending to use the device and a built-in processing unit which is able to process the network communication as well as the identification interface. The network interface 10, 20 provides the device with an address such as an IP-address or a MAC-address. Preferably the IP-address is static which means that the device does not change its address.

The identification interface 11, 21 can be a fingerprint reader, an iris scanner or any interface which reads the content of a security token. It is also possible that user enters a password via a small keyboard or via a microphone. The identification interface 11, 21 provides together with the built-in processing unit a set of identification data referring to the user. Said set of identification data will be transmitted together with the address of the device via the network interface to the network. With other words: A set of information comprising identification data of the user as well as the address of the device will be transmitted.

The built-in processing unit serves mainly as a processor of the identification data as well as of the input and output data which is sent via the network interface. Thereby the processing unit controls also the respective device. It has to be noted that the processing unit is designed such that it is able to process respective data, but main computing operations will be processed by means of the processing unit 6 which can be arranged as mentioned above at a remote location or in the vincinity of the input and output device.

Under the term peripheral device all kind of devices which can be linked to a computer systems are to be understood. It is possible to group the devices in a first group comprising input devices and in a second group comprising output devices. An input devices can be for example a keyboard, a mouse, touch screen, etc. with which the user can enter information or commands into the system. The output device can be a display, printer etc. with which the user can be provided with information from the system. Furthermore external storage devices such as external hard disks are also to be considered as peripheral device.

It has to be noted that any of the devices can be activated remotely through the network, which has the advantage that not all of the devices need to be at the same location. To make an example: A display and a keyboard are located on the desk of the user, whereas the external hard drive or the printer are arranged at a remote location. Thereby the user identifies himself vis-à-vis the devices being at the user's location. Afterwards the identification data is sent to the database 40 in the remote server 4. The database 40 in this embodiment comprises a table in which information regarding the usage of the devices at the remote location are stored. Said table will be questioned based on the identification data received from the devices at the user's location and the link between the remotely arranged devices and the local devices will be established. In this embodiment it is necessary to feed said table with the respective information beforehand. Alternatively it may also be possible to provide the user with a list from remote devices which are available.

Further devices can be:
PCI Chips having a network interface, whereby the computing power of the overall will increase
Medicine and physician equipment, such as telesurgery equipment or robotic surgery equipment
Remotely controlled robots or toys
House appliances
game controllers such as joysticks, steering wheels etc.
etc.

From the list above and the devices as mentioned herein, one can see that a myriad of kinds of devices can be connected together. However, each of the devices must have the ability to send and/or receive data through its network interface in order that said data can be managed and processed via a CPU which is located elsewhere.

With regard to FIG. 1 it has to be mentioned that a plethora of not shown further devices are linked to the network 3. Thereby the devices are operated by different users. A first user A for example intends to use word processing functions, thereby user A links via the remote server 4 and the network 3 a keyboard, a mouse with a computer screen all of which being arranged at his desk according to the method as described below. The remote server in this case is also able to perform operations regarding the word-processing functions. In case user A is also in the need to scan a document, it will be possible according to the invention to link also a further input device in this case a scanner to the three other devices. A second user B in the contrary would like to processes digital pictures from a digital camera. Thereby user B links the camera with the network 3 and links the camera with the computer screen via the network and the remote server 4.

For all linking procedures it is irrelevant where user A and user B physically are. Furthermore it is by no means necessary that user A and user B are in a relationship to each other. The only relationship between the user is that they use the same network. On the contrary it is also possible that user A and user B are employed in the same company and use the system which in this case can be a company network.

The network 3 is a computer network such as the internet for example allowing to transfer said set of data from said devices 1, 2 to the remote server as well as to connect several devices with each other.

The remote server 4 is arranged at a remote location. The remote server 4 comprises a database 40 and processor means for processing requests and/or computational tasks in case the processing unit 6′ is arranged with the remote server. The database 40 comprises information regarding rules which devices shall be linked together.

The database 40 comprises at least identification data of the user. The identification data comprise at least an identification parameter which can be validated against the set of identification data which is sent from the device 1, 2. This means that the database 40 will be queried upon receipt of data from the devices 1, 2.

Furthermore the database may optionally comprises data such as username, password, real names, addresses, credit card number etc. The optional data can be used for billing and other administrative purposes of the providers of the devices which are used by the user. To make an example: When the user wants to store information in a hard drive device at a remote location, the provider of said device may require that a fee for the usage of the memory is paid. The payment can be done by the credit card of the user.

With regard to the device 1, 2 it has to be noted that the device can also be a combination between input device and output device. Such an example is shown with element 9 in FIG. 1 in broken lines. The device 9 can be a touchscreen display serving as output device as well as input device. The same applies also to a mobile phone having a display and a keyboard for example. All of the devices have one identification address only, although they have the ability to serve as input and as output device.

The method to connect a first device with at least one second device comprises in principle the following steps:
in a first step the user identifies himself vis-à-vis the first device 1 and vis-à-vis the further device 2 over the identification interface 11, 21 wherein a set of identification data is generated by said identification interface 11, 21,
afterwards the set of identification data and the address of the respective device 1, 2 will be submitted to the remote server 3 as a set of information 5;
afterwards the database 40 in the remote server 4 will be queried based on said set of information and the link 8 will be established between the first device 1 and the further device 2.

Said set of information 5 can be encrypted by the devices 1, 2 and decrypted by the remote server or the database respectively.

To make a more illustrative explanation about the above mentioned method: In case the first device 1 is a keyboard, the second device 2 is a computer screen and a third device is a central processing unit 6, the user using said devices and the method has thereby a similar experience as when he uses a personal computer. The difference however, is that the central processing unit 6 is arranged at a remote location and the user has to identify himself vis-à-vis each of the devices being at his location and which he would like to use. As it will be explained below, there are several modes to choose the processing unit 6. The processing unit 6 can be chosen based:
on a request of the user which will be entered via the keyboard; or
on a predetermined entry in the database, preferably based on the identification information.

If the latter is the case, the database 40 comprises information which of the remote devices shall be linked together, when a certain user identifies himself vis-à-vis a input or output device.

The method as mentioned above can be implemented mainly in two embodiments. The first embodiment is more strict in terms of security issues than the second embodiment.

In the first embodiment the user has to perform a registering process before he is able to perform the above mentioned method. Thereby the user's data are entered and stored into the database 40. The identification data can be entered via the identification interface of the device. A list of possible identification data is mentioned above. Generally the identification data allows the identification of the user and the term encompasses a wide variety of identification data. The remote server 4 in this first embodiment will serve as processing 6′ unit to execute the processing request by the user. Alternatively the remote server provides a graphical user interface via which the user can choose an alternative processing unit 6 being arranged remotely.

After the registering process has been completed the method to link the at least two devices 1, 2 with each other can be performed.

In this first embodiment further queries can also be introduced in order to enhance security. Thereby it is possible that the database comprises a list with information about devices that can be linked together by a specific user. Thereby the user's right are restricted by the list. The information can be the MAC-Address or the IP-Address of the devices which can be linked together. With such a structure it is possible to link only certain devices together. This is particularly interesting, in case the users are employees of a company and said users shall link the devices in a secure manner. It may also be possible to allow usage of a certain device over a predetermined period of time, for example for one year or over a predetermined period of time frames such as office hours of a company.

The restriction concerning time may also include the feature when a billing process is involved that daytime usage is charged at a higher rate than nighttime usage.

Additionally or alternatively restriction can also be introduced by the following measures:
The user may choose specific devices which are fixedly allocated to the user. The information concerning the allocation is also stored in a table in the database 40. Thereby as soon as the user identifies himself, the available device will be linked automatically together or the user will be questioned regarding the devices he would like to use. The automatic linking process has the advantage that the user has to identify himself only once.
In a further embodiment the user can give permission to third parties to use devices which are managed by the user. Thereby user will amend a table in the database 40 which will then be questioned after a third party has requested access to said devices.

In the first embodiment it is also possible to use fixed combinations. For a fixed combination the IP-Address or the MAC-Address of the devices which shall be linked together will be stored. Once a certain user has registered himself vis-à-vis a first device the respective devices will be linked together. To make an example: The keyboard and a display being arranged at the user's location shall always be linked with the same remotely located processing unit. Once the user has identified himself vis-à-vis the keyboard and/or the display said method as mentioned above will be initiated. Thereby the set of information 5 will be sent to the database 40 of the remote server and the database 40 will perform the query. Based on the results of the query the devices will be linked together.

In the second embodiment a more liberal approach concerning the registration and security issues can be pursued. Thereby the registering process is not necessary. In this case the user simply identifies himself vis-à-vis the respective devices 1, 2 and each of the devices sends a set of information comprising the identification data entered by the user and the address of the device to the database 40. The step of querying the set of information comprises in this case the following sub-steps:
storing the set of information received from the first device within the database 40;
querying the database 40 upon receipt of a further set of information, if there is a matching set of information;
establishing a link 8 between the first device 1 and the further device 2, if a matching set of information is found.

In case the user would like to link an additional further device, the above mentioned sub-steps apart from the first sub-step will be repeated.

The remote server 4 in this second embodiment will serve as processing unit 6′ to execute the processing request by the user. Alternatively the remote server provides a graphical user interface via which the user can choose an alternative processing unit 6 being arranged remotely.

Optionally in both embodiments of the method, the set of information which has been mentioned above may also comprise information concerning the type of the device. In this case the set of information comprises at least identification information regarding the user, address information of the device and information regarding the type of the device. Information regarding the type of the device can be elementary such as input device or output device or it can be more sophisticated by comprising the exact type of the device including make, model, and/or serial number. The information concerning the type of the device will also be stored in a respective table in the database. Including the information of the type of the device has the advantage that operating system conflicts can be recognised and prevented. This means that only compatible devices will be linked together. Thereby the method to link two devices together can also comprise the step of running a compatibility check.

With regard to both embodiments the step of identification vis-à-vis a further device can also be performed by:
manually choosing said further device from a list which is provided for the first device, wherein said list is based on information stored in the database, thereby said list is displayed once the user has completed the identification step vis-à-vis the first device and
by an optional identification step vis-à-vis said further device, wherein said identification step includes an input of identification information, preferably via an other device or via the first device.

This means that the user identifies himself vis-à-vis the first device and afterwards as soon as the set of information (e.g. identification data and address of the device) is submitted to the remote server, the remote server provides a list for the first device, wherein said list shows all available further devices for the user. The optional identification step vis-à-vis the further device includes an input of identification information such as an input of a password via a keyboard or via the identification interface of the first device.

To make an example. A user using a computer screen with a fingerprint reader identifies himself vis-à-vis the computer screen which then sends the identification data and other related data according to the above mentioned set of information to the remote server. Based on said data the remote server provides a list with devices that may be chosen by the user. Once the user has made his choice, the first device will be linked to the second device. Optionally the user may also be required to provide his identification data for the further device.

Alternatively the remote server may also provide a field for the use and prompt the user to enter a phone number or an IP-address.

With regard to both embodiments the step of identification vis-à-vis a further device can also be performed by:
choosing said further device automatically based on predetermined rules from a list which is provided for the first device, wherein said list is based on information stored in the database and
by an optional identification step vis-à-vis said further device, wherein said identification step preferably includes an input of identification information.

This means that the user identifies himself vis-à-vis the first device and afterwards as soon as the set of information (e.g. identification data and address of device) is submitted to the remote server.

The method of processing a request from the user in case of an input device and an output device 2 is as follows:
The command will be entered into the input device 1.
The input devices generates an input packet (e.g. packet data) which is sent via the network 3 to the remote server 4.
Said input packet will be received by the remote server 4 which executes or processes the request of the user based on said input packet.
Afterwards the remote server generates an output packet which comprises the results of the execution and the output packet will be sent to the respective output device 2.
The output device 2 then provides the user with the results or act in accordance with instructions contained in the output packet.

Under the term processing request all requests that will be sent by the user are to be understood. For example: The user would like to use word-processing functionality, each strike on his keyboard is to be considered as processing request.

Additionally the step of processing the request at the remote server comprises the sub-step of forwarding the processing request to a remote processing unit being at a remote location from the remote server which executes or processes said request based on said input packet, wherein an output packet is generated by the remote processing unit, and wherein the output packet is sent to the remote server.

In order to enhance the capacity of the system bidirectional traffic could be allowed. This means that there is a constant exchange of input and output packets between the remote server and the respective device.

It is preferable to encrypt the packets that are exchanged over the network. For that reason each of the devices and the remote server can be equipped with encrypting/decrypting means.

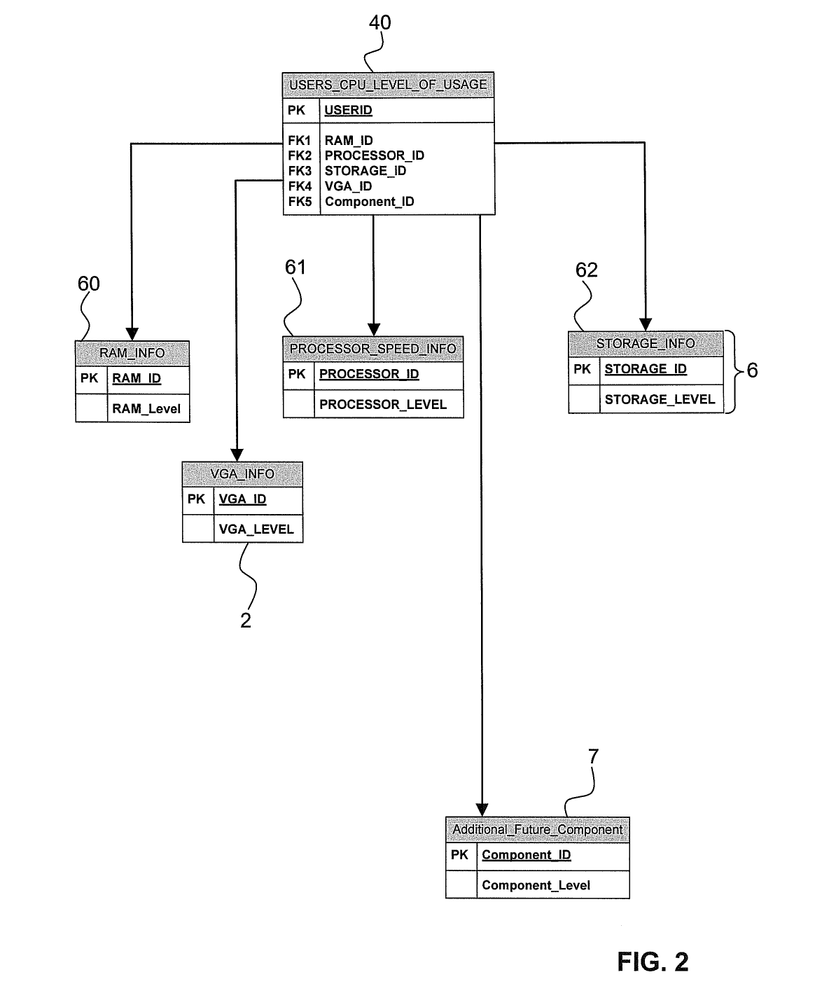

FIG. 2 shows a further schematic view of the system and/or method of the present invention. Same features are designated with the same reference numerals as in FIG. 1.

In block 40 which represents the authentication database it can be seen with PK USERID that in this block user related information will be processed. PK stands for primary key. Hence, once the user identifies himself vis-à-vis the devices a set of identification data will be generated and it will be sent via the network to the database 40 where it will be processed.

In this embodiment the database 40 comprises furthermore the functionality to link a processing unit 6 which comprises a random access memory device 60, a processor device 61 and a storage device 62 with the input and/or output device 1, 2, here a VGA-Device, as well as with any other future component 7. This is shown with the terms FK1 to FK5. FK stands for foreign key.

Furthermore the database 40 may allocate performance limits for the processing unit 6 which means that a share of the computational power of the processing unit 6 will be allocated to the user.

In the following paragraphs additional features will be described in connection with the method and the embodiments as described above.

The processing power of the remote server 4 can be subdivided and specifically allocated to certain users. The same applies also for storage means, such as hard drives, whereby it is possible to allocate certain storage power. The information how much processing power or storage power is allocated to a certain user can be stored in a table within the database 40.

The remote server can also comprises several operating systems which enables the user in choosing the respective operating system with which he would like to work on. Thereby the user will be provided with a graphical user interface, via which the user is able to enter the choice about which system he would like to use. Alternatively the operating system will be chosen automatically based on the type of the devices to be linked with each other.

The technical teaching as outlined herein may not only be used for computer systems. It may also be possible to equip means for transportation such as cars, ships, submarines, aircrafts or tanks with one of the devices that receives data from the car's monitoring system. Said data will then be submitted to a service station which comprises the remote server upon positive identification of the user of the car. For example when the user ignites the car. The key of the car would serve as an identification element in this case. The data can be submitted via wireless networks, such as WLAN or mobile phone networks.

The input and/or output devices may also have the shape of a mobile device, such as a mobile phone. Thereby the user enters the password via the keypad or via a built-in fingerprint reader. The mobile phone can be contacted via a phone network or via W-LAN or WIFI.

Furthermore the present method allows also resource sharing, whereby a user may assign a certain percentage of computational power which can be used by other users requesting further computational power. Thereby the database 40 comprises a table in which the percentage is of the available computational power and/or the requested computational power. The term computational power is to be understood to comprise everything in information technology that can be allocated such as the allocation of memory power, computing power, processing power etc..

Furthermore or alternatively the database comprises a table in which data concerning unused computational power of processing units is stored. Said table is questioned to assign computational power to users, such that available computational power can be summarised. The respective processing units are linked with the device or devices via which the user enters computational requests. This features allows a concentration of computational power where it is needed.

In case one of the linked devices is a printer it has to be noted that the printing data may be processed in a remote processing unit, whereby the data sent to the printer is already processed data. This means that the printer will be relieved from processing data. Therefore the printer can be equipped with a processor having lower computational power and is therefore cheaper.

The identification data can also be provided with a identification device that will be linked with the identification interface. Thereby the identification device can provide the identification data wireless to the identification device. It is possible that the identification interface is an RFID-gate which reads an RFID-chip arranged in the identification device, whereby the RFID-chip provides said identification data. Other type of transmission such as via WIFI or WLAN is also possible. With the use of such an identification device, the identification step may take place as soon as the user is in range of the identification interface.

Additionally the identification device can also comprises a GPS-module, whereby location based information is submitted, enabling the user to use location based information such as a menu of a nearby restaurant.

Furthermore the input and/or output devices may also be equipped with an interface to exchange data from an external data carrier such as an USB-Stick or an external hard drive.

The method as described herein may also be used to operate or link gaming devices such as joysticks, steering wheels etc. which are part of a game system. To make an example: A user intends to play a car racing game using an electronic steering wheel as input device 1 and a display as output device 2. The steering wheel and the display are linked according to the method as described herein. Namely the user identifies himself vis-à-vis the input device as well as the output device. Afterwards the devices will be linked together via a remote server 4. Processing operations regarding the game will be processed at the remote server or somewhere else.

With regard to this embodiment, the gaming devices have to be provided with the same features as the devices as mentioned above. Thereby the gaming devices comprising at least a network interface allowing communication with the network, an identification interface to identify a user intending to use the device and a built-in processing unit which is able to process the network communication as well as the identification interface.

Due to the demand on high computational power in view of special graphic effects, the network interface is preferably a internet high speed connection.

Additionally the identification information may also be used to generate a list of available users in the remote server. Said list is accessible by other users seeking a partner for a gaming session.

Alternatively the input device comprises a micro analog or digital video and audio broadcasting antenna or wire that could transmit the game picture on the TV in a PAL, SECAM or NTSC standard. Alternatively or optionally a projector in the gear or the controller if a TV or monitor is not available can be installed. The features may be arranged in a separate device that can be linked with the game device, in case the game device is not equipped with said features.

Linking game devices with the method according to the present invention has several advantages. First of all the user is provided with a very easy procedure to play a game and/or to link with other players. Furthermore the user has no need to have the processing unit at the location where the user would like to play the game which means that the user has not to care about buying a new console in case new games are issued requiring additional computational power.

But not only the user is experiencing advantages also the manufacturers of gaming software are provided with several advantages. Currently the problem arises that games which are distributed on CD-ROM or DVD will be copied by some of the users and distributed by them illegally. With the method according to the present invention the manufacturer has full control about the distribution, as the software remains on the server of the manufacturer. Furthermore the software can be easily updated by the manufacturer.

### LIST OF REFERENCE NUMERALS

| | |
|---|---|
| 1 | first device |
| 2 | second device |
| 3 | network |
| 4 | remote server |
| 5 | set of information |
| 6 | processing unit |
| 7 | future component |
| 8 | link |
| 9 | further device |
| 10 | network interface |
| 11 | identification interface |
| 20 | network interface |
| 21 | identification interface |
| 40 | database |
| 60 | memory device |
| 61 | processor device |
| 62 | storage device |

1. Method to link a first device that is linked with a network with at least one further device that is linked with the network, wherein a remote server having a database comprising information regarding rules to connect said devices with each other is linked to the network, wherein said connection is established via the network and the remote server;
wherein said devices comprise a network interface allowing communication with the network and an identification interface to identify a user, wherein
in a first step the user identifies himself vis-a′-vis the first device over the identification interface wherein a set of identification data is generated by said identification interface, whereby afterwards the set of identification data and the address of the first device will be submitted as a set of information to the remote server;
wherein in subsequent step the user identifies himself vis-a′-vis the further device over the identification interface wherein a set of identification data is generated by said identification interface, whereby afterwards the set of identification data and the address of the further device will be submitted as a set of information to the remote server;
wherein the database in the remote server will be queried based on said set of information; and
wherein the database establishes a link between the first device and the further device.

2. Method according to claim 1, wherein a remote processing unit which processes processing requests from the user will be linked automatically to the first and/or the further device by means of linking information stored in the database and/or wherein the remote server provides a graphical user interface with which the user can choose a remote processing unit.

3. Method according to claim 1, wherein the step of querying the
database includes the sub-steps of:
storing the set of information received from the first device.
querying the database upon receipt of a further set of information, if there is a matching set of information and
establishing a link between the first device and the further device, if a matching set of information is found.

4. Method according to claim 1, wherein a registering step is performed before the first step, whereby the user provides at least identity data concerning his identity and wherein said data is stored in the database.

5. Method according to claim 1, wherein the database comprises linking information in relation to identification data, whereby the input devices and/or the output devices are allocated to remote devices automatically once the identification data has been entered.

6. Method according to claim 1, wherein said set of information is encrypted by the respective devices and decrypted by the remote server or the database, respectively.

7. Method according to claim 1, wherein the identification data which has been entered via the first device will be stored in a table of the database and wherein said table is questioned every time upon receipt of further identification data from a further device, and wherein in case of matching identification data the first device will be linked with a further device.

8. Method according to claim 1, wherein the set of information comprises further information regarding the type of the device and wherein before establishing the link between the first device with a further device a compatibility check concerning the compatibility of the devices is performed and wherein the devices will be linked based on the outcome of this check.

9. Method according to claim 1, wherein the remote server or the remote processing unit comprises several operating systems, whereby the operating system will be chosen by the user or automatically based on the type of the devices.

10. Method according to claim 1, wherein the step of identification vis-a′-vis a further device is performed by manually choosing said further device from a list which is provided for the first device, wherein said list is based on information stored in the database and by an identification step vis-a′-vis said further device, wherein said identification step preferably includes an input of identification information.

11. Method according to claim 1, wherein the step of identification vis-a′-vis a further device is performed by choosing said further device automatically based on predetermined rules from a list which is provided for the first device, wherein said list is based on information stored in the database and by an identification step vis-a′-vis said further device, wherein said identification step preferably includes an input of identification information.

12. Method according to claim 1, wherein the database comprises a table in which data concerning unused computational power of processing units is stored, wherein said table is questioned to assign computational power to users, such that available computational power can be summarised, and wherein the respective processing units are linked with the device or devices via which the user enters computational requests.

13. Method of processing a request from the user by means of a first device and at least one further device, whereby the first device and the at least one further device are linked by a method according to claim 1, wherein
a command will be entered via the first device, such as an input device;
the first device generates an input packet which is sent via the network to the remote server;
wherein the remote server processes said request based on the input packet;
wherein an output packet is generated comprising the results of the execution of said request; and
wherein the output packet is sent to the at least one further device, such as an output device; and
wherein said at least one further device extracts said output packet and acts accordingly.

14. Method according to claim 13, wherein the step of processing the request at the remote server comprises the sub-step of forwarding the processing request to a remote processing unit being at a remote location from the remote server which executes or processes said request based on said input packet, wherein the output packet is generated by the remote processing unit, and wherein the output packet is sent to the remote server.

15. A system comprising at least a first device, a further device and a remote server all of which are connected with a network such as the internet, wherein said devices comprise a network interface allowing communication with the network and an identification interface to identify a user, wherein a link to exchange data packets between the first device, the further device and the remote server will be established according to the method of claim 1 and/or wherein a request from the user is processed according to the method of claim 13.
